(19) United States
(12) Patent Application Publication
(10) Pub. No.: US 2020/0183467 A1
(43) Pub. Date: Jun. 11, 2020

(54) APPLICATION POWER ALLOCATION

(71) Applicant: Hewlett-Packard Development Company, L.P., Spring, TX (US)

(72) Inventors: Raghu Anantharangachar, Bangalore (IN); Vani Narayan, Bangalore (IN)

(73) Assignee: Hewlett-Packard Development Company, L.P., Spring, TX (US)

(21) Appl. No.: 16/616,480

(22) PCT Filed: May 15, 2018
(86) PCT No.: PCT/US2018/032765

§ 371 Date: Nov. 24, 2019

(30) Foreign Application Priority Data
Jul. 20, 2017 (IN) 201741025824

(51) Int. Cl. G06F 1/18; G06F 1/3206

(52) U.S. Cl. CPC G06F 1/189; G06F 1/3206; G06F 1/188; G06F 1/182

(57) ABSTRACT

Examples disclosed herein relate to receiving, via a user interface, a power allocation for a first application, receiving a request to initiate the first application, and determining whether the first application has remaining power under its power allocation from a power supply. In response to determining that the first application has remaining power under its allocation from the power supply, the first application may be initiated.

### BACKGROUND

Mobile devices, such as smartphones, tablets, and laptops, are commonplace among users. These devices are often used for both business and recreational purposes, such as communication, navigation, and entertainment. Oftentimes, such functionality is provided by applications executing on the device.

### BRIEF DESCRIPTION OF THE DRAWINGS

In the accompanying drawings, like numerals refer to like components or blocks. The following detailed description references the drawings, wherein:

FIGS. 1A-1C are block diagrams of example power allocation user interfaces;

FIG. 2 is an example apparatus for providing power allocation;

FIG. 3 is a flowchart of an example of a method for providing power allocation; and

FIG. 4 is a block diagram of an example computing device for providing power allocation.

### DETAILED DESCRIPTION

In some situations, a user may have a device, such as a smartphone, tablet, laptop, or other similar electronic device that executes a number of different applications (“apps”). Often, these include applications of varying importance to the user. For example, a phone communication or navigation app may be of higher priority to the user than a game app. Each app, however, consumes power when executing on the device and users must keep track of remaining battery life when executing lower priority apps if they wish to be able to use higher priority apps.

In some implementations described herein, a battery manager may allow a user to set a minimum battery reserve to be used for certain apps. For example, a management profile may be installed on the mobile device that intercepts calls to the mobile device operating system. The management profile may consult with battery management rules when an app is requested to be run. If the device's battery level is below a minimum reserve threshold (e.g., 25% or 8000 mAh), then only certain identified high priority apps may be allowed to run on the device. The user may designate these apps, such as a phone app for emergency calls and/or a navigation app while traveling. In some implementations, independent reserves may be set for different apps, such as reserving 15% for the phone app, 10% for the navigation app, and 10% for a messaging app (e.g., text/SMS and/or email).

In some implementations described herein, the battery manager may allow a user to set a maximum battery quota to be used for certain apps. For example, a game app may be set to exit and/or stop executing after a certain amount of power has been consumed by the game app's execution. Individual apps may have a dedicated power allocation (e.g., each of three game apps may each consume 10% of the battery power before exiting) and/or a given quota allocation may be shared by multiple apps (e.g., all apps from the category “game” by consume no more than 25% of the battery power total).

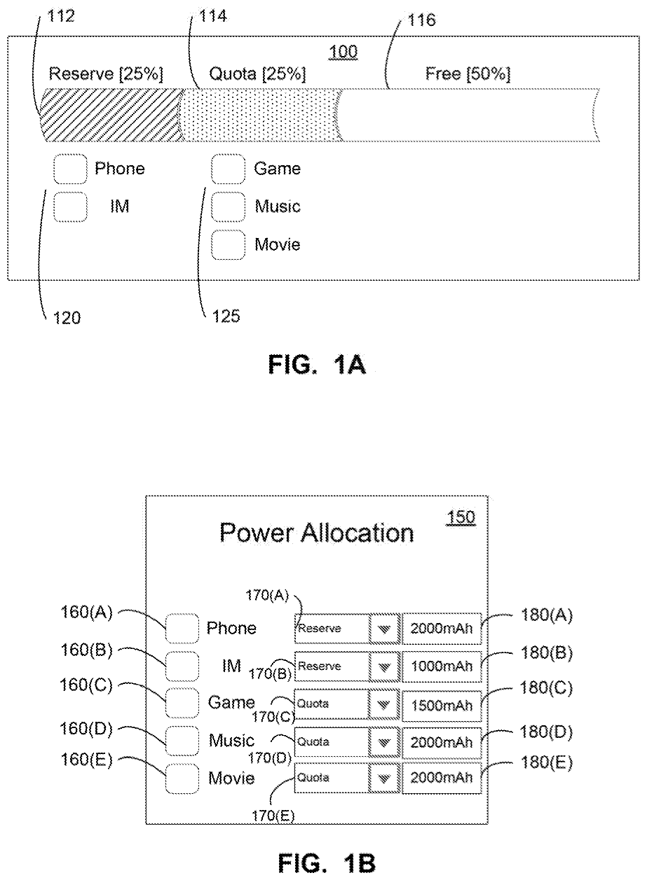

FIG. 1A is a block diagram of a first example power allocation user interface (UI) 100. UI 100 may comprise a battery representation 110 comprising a first allocation representation 112, a second allocation representation 114 and an unallocated representation 116. UI 100 may further comprise a first list of apps 120 associated with the first allocation representation 112 and a second list of apps 125 associated with the second allocation representation 114. App lists 120, 125 may comprise individual apps, groups of apps, and/or categories of apps, for example. In some implementations, a drag and drop type interface may be employed in UI 100 to allow a user to move apps between allocations 112, 114, 116. A similar list of apps not associated with allocations 112 and 114 may also be displayed in UI 100, for example below representation 116.

FIG. 1B is a block diagram of a second example power allocation user interface (UI) 150. Second UI 150 may comprise a list of apps 160(A)-(E), each associated with an allocation type selection 170(A)-(E) and a power allocation amount field 180(A)-(E). List of apps 160(A)-(E) may comprise individual apps, groups of apps, and/or categories of apps, for example. Allocation type selections 170(A)-(E) may allow a user to specify whether the amount of power indicated in the associated allocation amount field 180(A)-(E) represents a reserve, quota, or other type of allocation (e.g., shared). Herein a reserve power allocation represents an amount of power reserved to the associated app and/or group/category of apps and not to be used by other apps. A quota power allocation represents a maximum amount of power to be used by the associated app and/or group/category of apps.

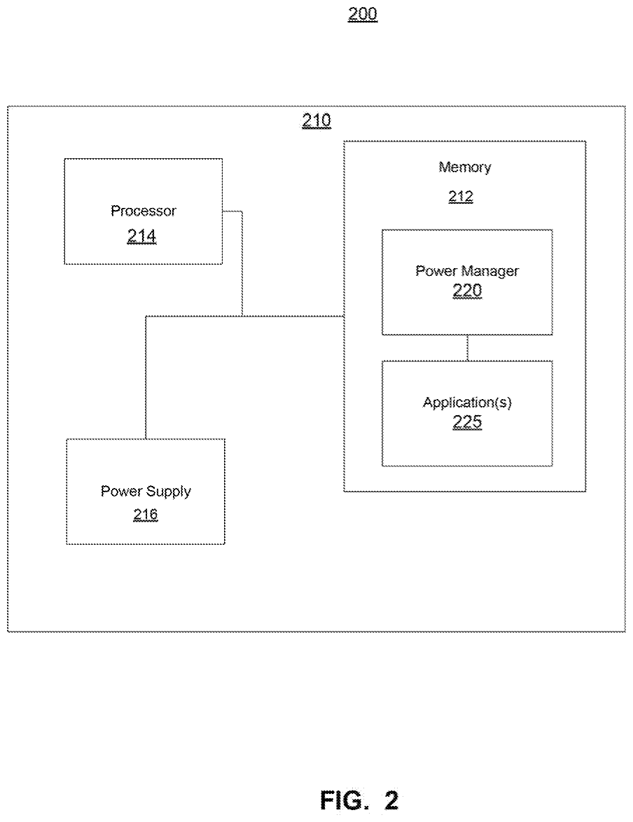

FIG. 2 is a black diagram of an example power allocation apparatus 200. Apparatus 200 may comprise a computing device 210 comprising a memory 212, a processor 214, and a power supply 216. Computing device 210 may comprise, for example, a general and/or special purpose computer, server, mainframe, desktop, laptop, tablet, smart phone, game console, printer and/or any other system capable of providing computing capability consistent with providing the implementations described herein. Computing device 210 may store, in memory 212, machine-readable instructions for executing a power manager 220 and a plurality of applications 225.

The machine-readable instructions 220, 225 of apparatus 200 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 220, 225. In such examples, apparatus 200 may comprise the machine-readable storage medium storing the instructions and the processing resource to execute the instructions, or the machine-readable storage medium may be separate but accessible to apparatus 200 and the processing resource.

Power manager 220 may assign a power allocation to a first application, and reserve a portion of available power from the power supply for the first application. For example, apparatus 200 may present a user interface, such as UI 100 and/or UI 150 allowing a user to set and/or confirm a minimum reserve power allocation. In some implementations, apparatus 200 may present a user interface, such as UI 100 and/or UI 150 allowing a user to set and/or confirm a maximum quota power allocation. The power allocation may be specified, for example, as a percentage of power available from power supply 216 and or an electrical measurement appropriate to power supply 216, such as in amperes and/or voltage. For example, where power supply 216 comprises a battery, 100% of the battery power may comprises a full charge.

In some implementations, power manager 220 may reserve the portion of available power from the power supply for the first application by preventing a second application from executing. A phone app, as an example, may be allocated a minimum reserve of 15% of the battery power, such that when device 210 has used 85% of the full charge, the phone app will be allowed to execute on the device while at least some other apps will be prevented from executing on the device.

In some implementations, an app may be considered to be executing when it is running in such a way to be providing output to a user of the device, such as by running in the foreground of a display on device 210. Other programs needed for the operation of the device, such as an operating system, cellular communication service, GPS process, etc. may continue to execute in the background without being considered to impinge on the minimum reserve power allocation. In some implementations, apps not allocated to the minimum reserve power allocation apps may be allowed to execute in the background of the device.

In some implementations, applications may be grouped for power allocations, such as by category (e.g., games, communication, productivity) and/or by priority. Lower priority applications may, for example, have power allocations reduced as remaining battery power diminishes and/or be prevented from executing when only enough battery power remains for a reserve power allocation for a higher priority application(s). For example, a phone application may comprise a high priority application and/or one of a plurality of high priority applications entitled to execute when remaining battery power is below a reserve power allocation threshold.

In some implementations, the power allocation may comprise an amount of available for power from a continuous supply. For example, device 210 may be plugged in to a continuous AC power source delivering 120 v. Power supply 216 may comprise an AC→DC transformer that supplies, for example 5 v DC to components of device 210. Execution of an app may cause device 210 to utilize some amount of the supplied power to the extent that the processor 214, memory 212, a display (not shown), interface components, etc. need power to operate. This power may, for example, be measured by the amount of current drawn by those components over time, such as milliAmperes per hour (mAh).

The power allocation may, for example, be expressed in terms of mAh and/or another electrical measurement unit. An app may be permitted to draw a certain amount of measured power, such as permitting a game app to draw 200 mAh before a quota power allocation is used up. The quota may, in some implementations, be reset upon configurable circumstances and/or at a configurable time, such as resetting when a battery is fully charged, when a continuous supply is connected/disconnected from device 210, and/or 24 hours after the quota allocation was reached.

Applications 225 may comprise different types of applications executable on device 210. In some implementations, a user may interact with at least some of applications 225 via a display and/or other interface, such as a touchscreen (not shown). Example applications may comprise various categories of applications, such as communication, entertainment, productivity, audio/visual apps, etc. For example, apps are available for texting, cameras, image viewing, video viewing, audio playback and/or recording, social media interactions, games, document creation and/or editing, photo sharing, email, phone, voice, SMS, and many other uses. In some implementations, each app may be, associated with a power allocation, individually and/or as part of a group and/or category. In some implementations, only some apps may be associated with power allocations, while other apps are free to utilize power not allocated to a reserve power allocation. For example, an unallocated app may use battery power that reduces the amount of available power below a quota allocation associated with another app.

In some implementations, power manager 220 may be associated with a device profile installed onto device 210 in accordance with provisions of the device's operating system (OS). Such a profile may utilize API calls provided by the OS to measure remaining battery power and/or power consumption. Similarly, the device profile may intercept calls from applications to the OS as those applications attempt to initialize and/or as the OS task-switches to those applications in order to enforce the power allocations.

Although one computing device 210 is depicted in FIG. 2, certain implementations of apparatus 200 may comprise more than one computing device 210. At least one of the computing devices may be employed and arranged, for example, in at least one server bank, computer bank, data center, and/or other arrangements. For example, the computing devices together may include a cloud computing resource, a grid computing resource, and/or any other distributed computing arrangement. Such computing devices may be located in a single installation and/or may be distributed among many different geographical locations.

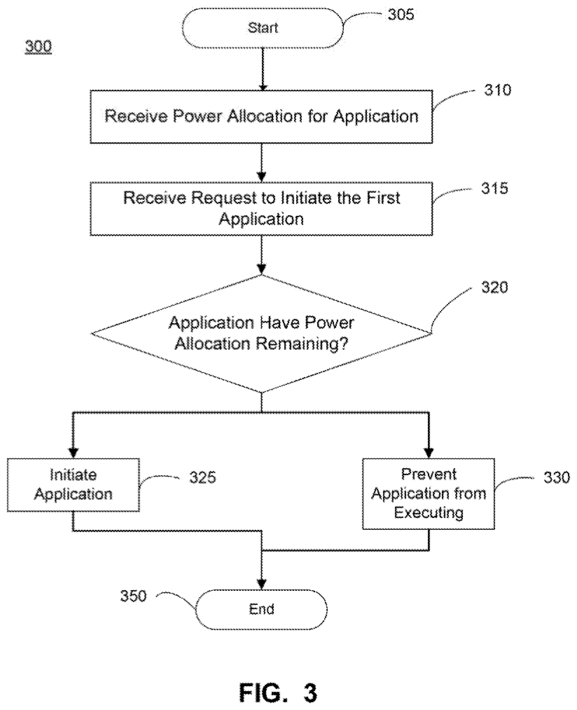

FIG. 3 is a flowchart of an example method 300 for providing document security. Although execution of method 300 is described below with reference to computing device 210, other suitable components for execution of method 300 may be used.

Method 300 may begin at stage 300 and advance to stage 310 where device 210 may receive, via a user interface, a power allocation for a first application. The power allocation may comprise, for example, a minimum reserve amount of power and/or a maximum quota amount of power from the power supply. For example, apparatus 200 may present a user interface, such as UI 100 and/or UI 150 allowing a user to set and/or confirm a minimum reserve power allocation. In some implementations, apparatus 200 may present a user interface, such as UI 100 and/or UI 150 allowing a user to set and/or confirm a maximum quota power allocation. The power allocation may be specified, for example, as a percentage of power available from power supply 216 and or an electrical measurement appropriate to power supply 216, such as in amperes and/or voltage. For example, where power supply 216 comprises a battery, 100% of the battery power may comprises a full charge. In some implementations, power manager 220 may reserve the portion of available power from the power supply for the first application by preventing a second application from executing. A phone app, as an example, may be allocated a minimum reserve of 15% of the battery power, such that when device 210 has used 85% of the full charge, the phone app will be allowed to execute on the device while at least some other apps will be prevented from executing on the device.

Method 300 may then advance to stage 315 where device 210 may receive a request to initiate the first application. Applications 225 may comprise different types of applications executable on device 210. In some implementations, a user may interact with at least some of applications 225 via a display and/or other interface, such as a touchscreen (not shown). Example applications may comprise various categories of applications, such as communication, entertainment, productivity, audio/visual apps, etc. For example, apps are available for texting, cameras, image viewing, video viewing, audio playback and/or recording, social media interactions, games, document creation and/or editing, photo sharing, email, phone, voice, SMS, and many other uses. In some implementations, each app may be associated with a power allocation, individually and/or as part of a group and/or category. In some implementations, only some apps may be associated with power allocations, while other apps are free to utilize power not allocated to a reserve power allocation. For example, an unallocated app may use battery power that reduces the amount of available power below a quota allocation associated with another app.

Method 300 may then advance to stage 315 where device 210 may determine whether the first application has remaining power under its power allocation from a power supply. For example, a low priority app icon may be tapped by a user of a device in order to start the initialization process of the app. Power manager 220 may determine whether the app has is entitled to reserve power, has a quota, and/or is not associated with a power allocation. If the app has a power quota, power manager 220 may determine whether any power remains under that quota allocation. In some implementations, power manager 220 may be associated with a device profile installed onto device 210 in accordance with provisions of the device's operating system (OS). Such a profile may utilize API calls provided by the OS to measure remaining battery power and/or power consumption. Similarly, the device profile may intercept calls from applications to the OS as those applications attempt to initialize and/or as the OS task-switches to those applications in order to enforce the power allocations. In some implementations, remaining power for the application may be reset on certain conditions. For example, measured power consumption against a quota allocation may be reset upon the power supply receiving a full charge.

In response to determining that the first application has remaining power under its allocation from a power supply, method 300 may then advance to stage 325 where device 210 may initiate the first application. For example, the app may start normally and display on the foreground of a display.

In response to determining that the first application does not have remaining power under its allocation from the power supply, method 300 may then advance to stage 330 where device 210 may prevent execution of the first application. The app, for example, may not be loaded into memory or allowed to use processing power. In some implementations, a notice may be displayed to a user that the app does not have any power allocation remaining.

Method 300 may then end at stage 350.

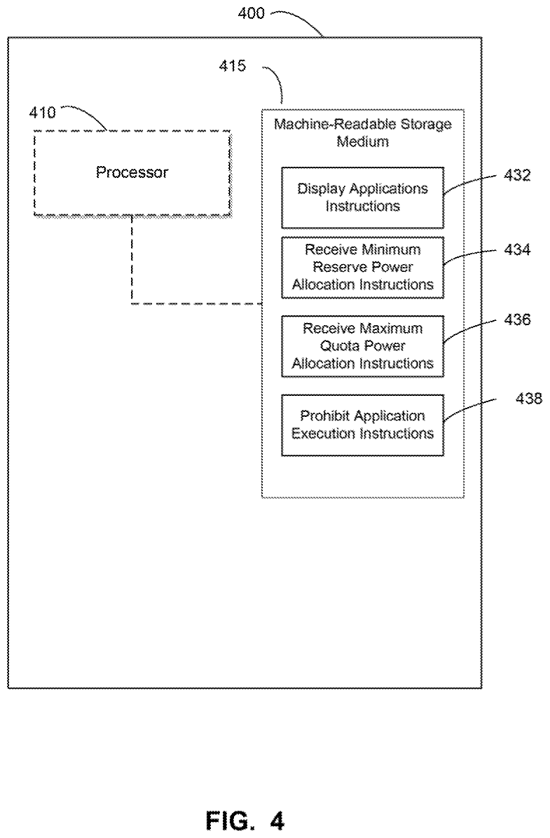

FIG. 4 is a block diagram of an example computing device 400 for providing document security. Computing device 400 may comprise a processor 410 and a memory 415 comprising, a non-transitory, machine-readable storage medium. Memory 415 may comprise a plurality of processor-executable instructions, such as display applications instructions 432, receive minimum reserve power allocation instructions 434, receive maximum quota power allocation instructions 436, and prohibit application execution instructions 438. In some implementations, instructions 432, 434, 436, 438 may be associated with a single computing device 400 and/or may be communicatively coupled among different computing devices such as via a direct connection, bus, or network.

Processor 410 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 420. In particular, processor 110 may fetch, decode, and execute instructions 432, 434, 436, 438.

Executable instructions 432, 434, 436, 438 may comprise logic stored in any portion and/or component of machine-readable storage medium 415 and executable by processor 410. The machine-readable storage medium 415 may comprise both volatile and/or nonvolatile memory and data storage components. Volatile components are those that do not retain data values upon loss of power. Nonvolatile components are those that retain data upon a loss of power.

The machine-readable storage medium 415 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Display applications instructions 432 may display, on a user interface, a list of applications. For example, apparatus 200 may present a user interface, such as UI 100 and/or UI 150 allowing a user to set and/or confirm a minimum reserve power allocation. In some implementations, apparatus 200 may present a user interface, such as UI 100 and/or UI 150 allowing a user to set and/or confirm a maximum quota power allocation. The power allocation may be specified, for example, as a percentage of power available from power supply 216 and or an electrical measurement appropriate to power supply 216, such as in amperes and/or voltage. For example, where power supply 216 comprises a battery 100% of the battery power may comprises a full charge.

Receive minimum reserve power allocation instructions 434 may receive, for a first application, a minimum reserve power allocation.

Receive maximum quota power allocation instructions 436 may receive, for a second application, a maximum quota power allocation.

Applications 225 may comprise different types of applications executable on device 210. In some implementations, a user may interact with at least some of applications 225 via a display and/or other interface, such as a touchscreen (not shown). Example applications may comprise various categories of applications, such as communication, entertainment, productivity, audio/visual apps, etc. For example, apps are available for texting, cameras, image viewing, video viewing, audio playback and/or recording, social media interactions, games, document creation and/or editing, photo sharing, email, phone, voice, SMS, and many other uses. In some implementations, each app may be associated with a power allocation, individually and/or as part of a group and/or category. In some implementations, only some apps may be associated with power allocations, while other apps are free to utilize power not allocated to a reserve power allocation. For example, an unallocated app may use battery power that reduces the amount of available power below a quota allocation associated with another app.

In some implementations, the power allocation may comprise an amount of available for power from a continuous supply. For example, device 210 may be plugged in to a continuous AC power source delivering 120 v. Power supply 216 may comprise an AC→DC transformer that supplies, for example 5 v DC to components of device 210. Execution of an app may cause device 210 to utilize some amount of the supplied power to the extent that the processor 214, memory 212, a display (not shown), interface components, etc. need power to operate. This power may, for example, be measured by the amount of current drawn by those components over time, such as milliAmperes per hour (mAh).

The power allocation may, for example, be expressed in terms of mAh and/or another electrical measurement unit. An app may be permitted to draw a certain amount of measured power, such as permitting a game app to draw 200 mAh before a quota power allocation is used up. The quota may, in some implementations, be reset upon configurable circumstances and/or at a configurable time, such as resetting when a battery is fully charged, when a continuous supply is connected/disconnected from device 210, and/or 24 hours after the quota allocation was reached.

Prohibit application execution instructions 438 may prohibit the second application from executing once the maximum power allocation is consumed and/or prohibit any application other than the first application from executing once available power from a power supply reaches the minimum reserve power allocation. For example, power manager 220 may reserve the portion of available power from the power supply for the first application by preventing a second application from executing. A phone app, as an example, may be allocated a minimum reserve of 15% of the battery power, such that when device 210 has used 85% of the full charge, the phone app will be allowed to execute on the device while at least some other apps will be prevented from executing on the device. An app prohibited from executing, for example, may not be loaded into memory or allowed to use processing power. In some implementations, a notice may be displayed to user that the app does not have any power avocation remaining.

The disclosed examples may include systems, devices, computer-readable storage media, and methods for document element re-positioning. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

What is claimed is:

1. An apparatus, comprising:
a power supply; and
a processor, the processor to execute a power manager and a plurality of applications, wherein the power manager is configured to:
assign a power allocation to a first application, and
reserve a portion of available power from the power supply for the first application.

2. The apparatus of claim 1, wherein the power allocation comprises a percentage of the available power from the power supply.

3. The apparatus of claim 1, wherein the power allocation comprises n amperage amount of the available power from the power supply.

4. The apparatus of claim 1, wherein the power manager is further configured to reserve the portion of available power from the power supply for the first application by preventing a second application from executing.

5. The apparatus of claim 4, wherein the second application comprises a lower priority application.

6. The apparatus of claim 4, wherein the first application comprises one of a plurality of high priority applications.

7. The apparatus of claim 1, wherein the application comprises a phone application.

8. The apparatus of claim 1, wherein the power allocation is received via a user interface on the apparatus.

9. The apparatus of claim 8, wherein the user interface displays list of at least a subset of the plurality of applications.

10. The apparatus of claim 8, wherein the user interface is configured to receive, for each of the displayed applications, at least one of a power reserve and a power quota.

11. A method comprising:
receiving, via a user interface, a power allocation for a first application;
receiving a request to initiate the first application;
determining whether the first application has remaining power under its power allocation from a power supply; and
in response to determining that the first application has remaining power under its allocation from the power supply, initiating the first application.

12. The method of claim 11, wherein the power allocation comprises a minimum reserve amount of power from the power supply.

13. The method of claim 11, wherein the power allocation comprises a maximum quota amount of power from the power supply.

14. The method of claim 11, further comprising resetting a power consumption measurement for the first application upon the power supply receiving a full charge.

15. A non-transitory machine readable medium storing instructions executable by a processor to:
display, on a user interface, a list of applications;
receive, for a first application, a minimum reserve power allocation;
receive, for a second application, a maximum quota power allocation;
prohibit the second application from executing once the maximum power allocation is consumed; and
prohibit any application other than the first application from executing once available power from a power supply reaches the minimum reserve power allocation.
